(19) United States
(12) Patent Application Publication
(10) Pub. No.: US 2021/0118236 A1
(43) Pub. Date: Apr. 22, 2021

(54) METHOD AND APPARATUS FOR PRESENTING AUGMENTED REALITY DATA, DEVICE AND STORAGE MEDIUM

(71) Applicant: BEIJING SENSETIME TECHNOLOGY DEVELOPMENT CO., LTD., Beijing (CN)

(72) Inventor: Xinru Hou, Beijing (CN)

(21) Appl. No.: 17/134,795

(22) Filed: Dec. 28, 2020

Related U.S. Application Data
(63) Continuation of application No. PCT/CN2020/112280, filed on Aug. 28, 2020.

(30) Foreign Application Priority Data
Oct. 15, 2019 (CN) 201910979920.5

(51) Int. Cl. G06T 19/00; G06T 7/70

(52) U.S. Cl. CPC G06T 19/006; G06T 2207/30244; G06T 7/70

(57) ABSTRACT

A method for presenting AR data includes: obtaining position information of an AR device; when it is detected that a position corresponding to the position information is located within a position range of a target reality area, obtaining special effect data of a virtual object associated with the target reality area; and displaying, in the AR device based on the special effect data of the virtual object, the AR data including the special effect data of the virtual object.

### CROSS-REFERENCE TO RELATED APPLICATION

This application is a continuation of International Patent Application PCT/CN2020/112280, filed on Aug. 28, 2020, which claims priority to Chinese Patent Application No. 201910979920.5, filed on Oct. 15, 2019. The disclosures of International Patent Application PCT/CN2020/112280 and Chinese Patent Application No. 201910979920.5 are hereby incorporated by reference in their entireties.

### BACKGROUND

Augmented reality (AR) technology superimposes physical information (visual information, sound and tactile sense, etc.) subjected to simulation into a real world, so as to present a real environment and virtual objects on a same screen or in a same space in real time. The optimization of the effect of AR scenes presented by AR devices is becoming increasingly important.

### SUMMARY

The present disclosure relates to the field of augmented reality (AR) technology, and relates to a method and an apparatus for presenting AR data, a device and a storage medium.

In view of this, the present disclosure provides at least a method and an apparatus for presenting augmented reality (AR) data, a device and a storage medium.

In a first aspect, the present disclosure provides a method for presenting AR data, including: obtaining position information of an AR device; when it is detected that a position corresponding to the position information is located within a position range of a target reality area, obtaining special effect data of a virtual object associated with the target reality area; and displaying, in the AR device based on the special effect data of the virtual object, the AR data including the special effect data of the virtual object. In this way, each target reality area has an associated virtual object, and the associated virtual object is located within the target reality area or outside the target reality area. In an embodiment of the present disclosure, the AR device displays, when located within the target reality area, the special effect data of the virtual object associated with the target reality area, meeting individual needs of displaying virtual objects in different real areas.

In a second aspect, the present disclosure provides an apparatus for presenting AR data. The apparatus includes a memory storing processor-executable instructions; and a processor arranged to execute the stored processor-executable instructions to perform operations of: obtaining position information of an AR device; when it is detected that a position corresponding to the position information is located within a position range of a target reality area, obtaining special effect data of a virtual object associated with the target reality area; and displaying, in the AR device based on the special effect data of the virtual object, the AR data including the special effect data of the virtual object.

In a third aspect, the present disclosure provides a non-transitory computer-readable storage medium having stored thereon computer-readable instructions that, when executed by a processor, cause the processor to performing operations of: obtaining position information of an AR device; when it is detected that a position corresponding to the position information is located within a position range of a target reality area, obtaining special effect data of a virtual object associated with the target reality area; and displaying, in the AR device based on the special effect data of the virtual object, the AR data comprising the special effect data of the virtual object.

In order to make the objectives, features and advantages of the present disclosure more obvious and understandable, preferred embodiments are described in detail below in conjunction with accompanying drawings.

### BRIEF DESCRIPTION OF THE DRAWINGS

FIG. 1 shows a schematic flowchart of a method for presenting AR data provided by an embodiment of the present disclosure;

FIG. 2 shows a schematic diagram of a target position area provided by an embodiment of the present disclosure;

FIG. 3A shows a schematic diagram of an area within a set distance range from a target reality area provided by an embodiment of the present disclosure;

FIG. 3B shows another schematic diagram of an area within a set distance range from a target reality area provided by an embodiment of the present disclosure;

FIG. 4 shows a schematic diagram of a shooting orientation provided by an embodiment of the present disclosure;

FIG. 5 shows a schematic flowchart of another method for presenting AR scene provided by an embodiment of the present disclosure;

FIG. 6 shows a schematic structural diagram of an apparatus for presenting AR data provided by an embodiment of the present disclosure;

FIG. 7 shows another apparatus for presenting AR data provided by an embodiment of the present disclosure;

FIG. 8 shows a schematic structural diagram of an electronic device provided by an embodiment of the present disclosure; and

FIG. 9 shows a schematic structural diagram of another electronic device provided by an embodiment of the present disclosure.

### DETAILED DESCRIPTION

In order to make the objectives, technical solutions and advantages of the embodiments of the present disclosure clearer, the technical solutions in the embodiments of the present disclosure will be described clearly and completely in conjunction with the accompanying drawings in the embodiments of the present disclosure. Obviously, the described embodiments are only a part of the embodiments of the present disclosure, not all the embodiments. The components of the embodiments of the present disclosure generally described and illustrated in the drawings herein may be arranged and designed in various different configurations. Therefore, the following detailed description of the embodiments of the present disclosure provided in the accompanying drawings is not intended to limit the scope of the claimed present disclosure, but merely represents selected embodiments of the present disclosure. Based on the embodiments of the present disclosure, all other embodiments obtained by those skilled in the art without creative work shall fall within the protection scope of the present disclosure.

The present disclosure can be applied to electronic devices (such as mobile phones, tablets and AR glasses, etc.) or servers that support AR technology, or a combination thereof. When the present disclosure is applied to a server, the server can be connected with other electronic devices with communication functions and cameras, and the connection method may be a wired connection or a wireless connection. The wireless connection may be, for example, a Bluetooth connection, a Wireless Fidelity (WIFI) connection, etc.

Presenting an AR scene in an AR device means displaying in the AR device a virtual object integrated into a real scene. There are two presentation methods. One is to directly render a presented picture of the virtual object and integrate the presented picture of the virtual object with the real scene, such as realizing a presented effect of a virtual tea set being placed on a real desktop in the real scene when presenting the virtual tea set. The other is to present a displayed picture that integrates a presented special effect of the virtual object with a real scene image. The choice of presentation method depends on the device type of the AR device and the adopted technology for scene presentation. For example, generally, since the real scene (not the real scene image after image formation) can be directly seen from an AR glasses, the AR glasses can adopt the presentation method of directly rendering the presented picture of the virtual object. As for mobile terminal devices such as mobile phones and tablet computers, since the picture displayed in the mobile terminal devices is the picture of the real scene after image formation, the method of integrating the real scene images with the presented special effect of the virtual object can be adopted to display the effect of AR.

In the embodiments of the present disclosure, each target reality area is associated with special effect data of a virtual object that can be displayed in the target reality area, and the virtual object associated with the target reality area can be located within the target reality area or outside the target reality area, in order to meet the personalized needs of displaying the virtual object in different target reality areas.

A method for presenting AR data related to an embodiment of the present disclosure will be described in detail below.

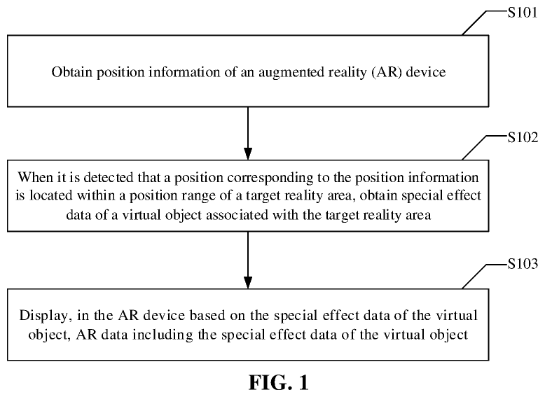

Referring to FIG. 1, which is a schematic flowchart of a method for presenting AR data provided by an embodiment of the present disclosure, the method includes the following operations.

In S101, position information of an AR device is obtained.

In S102, when it is detected that a position corresponding to the position information is located within a position range of a target reality area, special effect data of a virtual object associated with the target reality area is obtained.

In S103, AR data including the special effect data of the virtual object is displayed in the AR device based on the special effect data of the virtual object.

To detect that the position information of the AR device is located within the position range of the target reality area, any one of following methods can be performed.

In a first method, responsive to that geographic coordinates of the position information fall within geographic coordinate range of the target reality area, it can be detected that the position corresponding to the position information is located within the position range of the target reality area.

In some embodiments, the geographic coordinate range of the target reality area may be pre-stored or preset, and then whether the geographic coordinates corresponding to the position information of the AR device are within the geographic coordinate range of the target reality area is detected. If so, it is determined that the position information of the AR device is located within the position range of the target reality area. If not, it is determined that the position information of the AR device is not within the position range of the target reality area.

Herein, the special effect data of the virtual object associated with the target reality area can be in the AR device located within the target reality area, and the actual position in the real scene, where the virtual object is actually integrated into, is not necessarily within the target reality area. For example, at the roof of a certain building, a special effect picture of a virtual object on the roof of an opposite building can be seen. If the position information of the AR device is not within the position range of the target reality area, the special effect data of the virtual object associated with the target reality area will not be presented in the AR device. For example, after the AR device enters into the area of Yuanmingyuan ruins, the special effect picture of a restored Yuanmingyuan can be presented in the AR device. For the AR device that is not located within the area of Yuanmingyuan ruins, no special effect picture of restored Yuanmingyuan will be presented.

In a second method, based on the position information of the AR device and the information of the corresponding geographic position of the virtual object in the real scene, a distance between the AR device and the corresponding geographic position of the virtual object in the real scene is determined, and then responsive to that a determined distance is less than a set distance, it is determined that the position corresponding to the position information is located within the position range of the target reality area.

The second method is applicable to the situation that the virtual object is located within the target reality area. Herein, the target reality area refers to an area with the corresponding geographic position of the virtual object in the real scene as a center and a set distance as a radius. Detecting whether the position information of the AR device is within the target reality area can be understood as detecting whether the distance between the position of the AR device and the virtual object is less than the set distance.

This method provides a way to determine whether to present the virtual object in the AR device directly based on the distance between the AR device and the geographic position of the virtual object in the real scene. In this method, the coordinate information of geographic position of the AR device and the corresponding coordinate information of geographic position of the virtual object in the real scene are used.

In a possible implementation, the virtual object associated with the target reality area may be one or more of virtual bodies, sounds, and smells.

In an example of the present disclosure, obtaining the special effect data of the virtual object associated with the target reality scene may include at least one of: obtaining the special effect data of the virtual object whose corresponding geographic position in the real scene is located within the position range of the target reality area (referred to as special effect data of a first virtual object); or obtaining the special effect data of a virtual object whose corresponding geographic position in a real scene is located outside the position range of the target reality scene area (referred to as special effect data of a second virtual object).

In the case that the obtained special effect data of the virtual object associated with the target reality scene includes both the special effect data of the first virtual object and the special effect data of the second virtual object, the special effect data of the virtual object associated with the target reality scene may include the special effect data of multiple virtual objects.

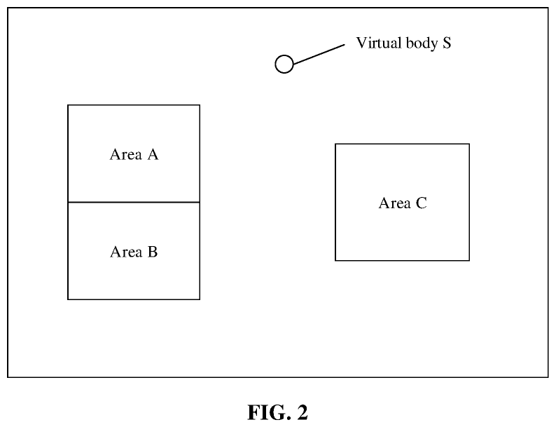

In addition, different target reality areas can be associated with special effect data of a same virtual object. Exemplarily, as shown in FIG. 2, in the real scene shown in FIG. 2, area A, area B and area C are three different target reality areas, and the special effect data of the virtual object is the special effect data of a virtual body S in the figure. The corresponding geographic position of the virtual body S in the real scene is located within the area A, and the area A, the area B and the area C are all associated with virtual body S. Then, in the case that the AR device is located within any one of the area A, the area B or the area C, the special effect data of the associated virtual body S can be presented in the AR device.

In some embodiments, obtaining the special effect data of the virtual object whose corresponding geographic position in the real scene is located outside the position range of the target reality area may be obtaining special effect data of a virtual object whose corresponding geographic position in the real scene is located outside the position range of the target reality area and which meets a preset condition.

The preset conditions include at least one of:

a distance from the corresponding geographic position of the virtual object in the real scene to the target reality area is within a set distance range; or

a shooting orientation of the AR device is within a set orientation range.

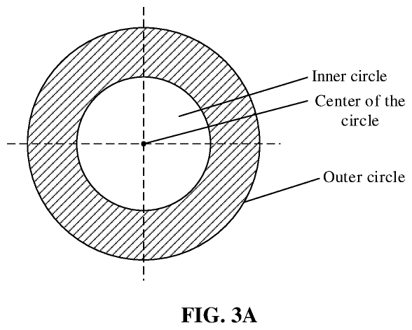

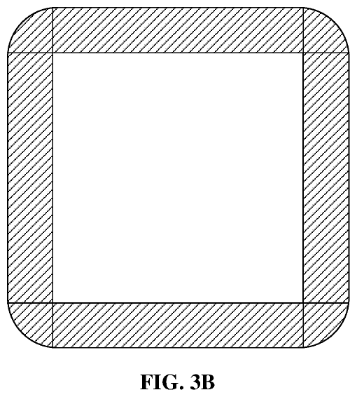

Exemplarily, as shown in FIG. 3A, if the target reality area is a circular area of the inner circle in the figure, the area within the set distance range from the target reality area is the area between the outer circle and the inner circle. For another example, as shown in FIG. 3B, if the target reality area is a rectangular area in the figure, the area within the set distance range from the target reality area is the shaded area in the figure.

In some embodiments, the virtual object may be associated with a target reality area in the real scene where the virtual object is located, or may not be associated with the target reality area. When the virtual object is associated with the target reality area, the special effect data of the virtual object may be presented when the AR device is located within the target reality area. When the virtual object is not associated with the target reality area, the special effect data of the virtual object may not be presented when the AR device is located within the target reality area.

In another possible implementation, when obtaining special effect data of the virtual object associated with the target reality area, the shooting orientation of the AR device may be detected first, and then the special effect data of a virtual object associated with both the target reality area and the shooting orientation is obtained.

In some embodiments, the special effect data of each virtual object may be pre-bound to a shooting orientation range, and obtaining the special effect data of the virtual object associated with both the target reality area and the shooting orientation may include: obtaining the special effect data of the virtual object whose corresponding geographic position in the real scene is located within the position range of the target reality area and whose pre-bound shooting orientation range includes the shooting orientation of the AR device.

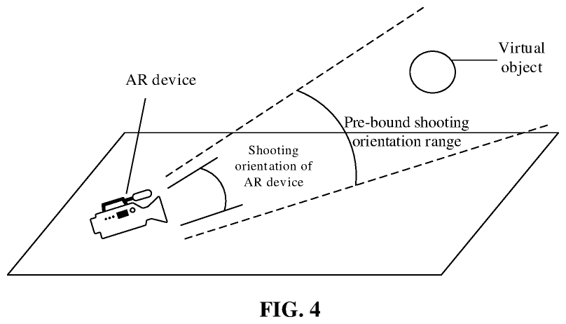

An exemplary application scenario is shown in FIG. 4. In FIG. 4, the corresponding geographic position of the virtual object in the real scene and the position information of the AR device are in the same target reality area, and the shooting orientation of the AR device is within the shooting orientation range pre-bound to the virtual object. In such a situation, the AR data displayed by the AR device includes the special effect data of the virtual object.

Shooting pose data of the AR device can be obtained in many ways. For example, when the AR device is equipped with a positioning component detecting positions and an angular velocity sensor detecting shooting orientations, the shooting pose data of the AR device can be determined through the positioning component and the angular velocity sensor. When the AR device is equipped with an image collection component, such as a camera, the shooting orientation can be determined by the real scene image collected by the camera.

The angular velocity sensor may include for example a gyroscope, an inertial measurement unit (IMU), etc. The positioning component may include for example a global positioning system (GPS), a global navigation satellite system (GLONASS) and a positioning component using wireless fidelity (WiFi) positioning technology.

In a possible implementation, obtaining the special effect data of the virtual object associated with the target reality area includes obtaining pose data of the AR device in a real scene; and based on the pose data of the AR device in the real scene and pose data of the virtual object in a three-dimensional scene model used for representing the real scene, determining the special effect data of the virtual object associated with the target reality area.

Herein, based on the shooting pose data of the AR device and the preset pose data of the virtual object in the three-dimensional scene model used for representing the real scene, the to-be-presented special effect data of the virtual object in the real scene is determined. Herein, because the three-dimensional scene model can represent the real scene, the pose data of the virtual object constructed based on the three-dimensional scene model can be better integrated into the real scene. The to-be-presented special effect data matching the pose data of the AR device can be determined from the pose data of the virtual object in the three-dimensional scene model, and then the effect of realistic AR scenes can be displayed in the AR device.

The pose data of the virtual object in the three-dimensional scene model used for representing the real scene may include position information (for example, the position information may be coordinates and the coordinates are unique) and/or corresponding attitude information of the virtual object in the three-dimensional scene model. The special effect data of the virtual object may be a presentation state of the virtual object. For example, the virtual object may be a virtual body displayed in a static or dynamic way, a certain sound or the like. In case that the virtual object is a dynamic object, the pose data of the virtual object in the three-dimensional scene may include multiple sets of position information (such as coordinate information of geographic position) and/or corresponding attitude information (i.e., displayed attitude of the virtual object). In a scenario, the multiple sets of position information and/or attitude information may correspond to a segment of animation video data, and each set of position information and/or attitude information may correspond to a frame of this segment of animation video data.

In order to facilitate the rendering of the special effect data of the virtual object and restore the displayed special effect of the virtual object in the three-dimensional scene model, the three-dimensional scene model in the displayed picture including the displayed special effect of the virtual object and the three-dimensional scene model can be transparentized. In the subsequent rendering stage, the displayed picture including the displayed special effect of the virtual object and the transparentized three-dimensional scene model can be rendered, and the real scene can be matched with the three-dimensional scene model. In this way, the displayed special effect of the virtual object in the three-dimensional scene model can be obtained in the real world.

In some embodiments, after the pose data of the AR device in the real scene is determined, a set of position information and/or attitude information of the virtual object matching the pose date of the AR device can be determined from multiple sets of position information (such as coordinate information of geographic position) and/or corresponding attitude information (i.e., display attitude of the virtual object) of the virtual object in the three-dimensional scene model. For example, a set of positions and attitudes of the virtual object matching with the pose date of the AR device is determined from multiple sets of position information and attitude information of the virtual object in the constructed building model scene.

In the case of displaying, in the AR device based on the special effect data of the virtual object, the AR data including the special effect data of the virtual object, depending on the type of AR device and the type of the special effect data of the virtual object, each type of special effect data is displayed respectively, or multiple types of special effect data are displayed in a combined way.

(1) In the case that the sound is included in the virtual object, the special effect data of the virtual object may be a sound with a fixed-frequency, and displaying the AR data including the special effect data of the virtual object may be playing a sound associated with the target reality area.

For example, if the special effect data of the virtual object associated with the target reality area is a certain sound clip, in the case of detecting that the position information of the AR device is located within the position range of the target reality area, the sound associated with the target reality area can be obtained, and the sound is played in the AR device.

(2) In the case that the smell of the real scene is included in the virtual object, after it is recognized that the position information of the AR device is located within the position range of the target reality area, a type of smell associated with the target reality area and a length of the time for releasing the smell are determined, and the determined type of the smell and the length of the time for releasing the smell are sent to a third-party device controlling the release of the smell, and the third party device controlling the release of the smell is instructed to release the corresponding type of smell for this length of time.

(3) In the case that a presented picture of the virtual body is included in the virtual object, the special effect data of the virtual object may be the presented picture of the virtual body, and the presented picture may be static or dynamic. The AR data may include AR image. Depending ion types of AR devices, AR images may be presented in different presentation methods.

A possible presentation method, which can be applied in AR glasses, can display the virtual body at a corresponding position of the lens of the AR glasses based on the preset position information of the virtual body in the real scene. In the case that the user views the real scene through the lens of the AR glasses displaying the virtual body, the virtual body can be seen at the position of the virtual body in the real scene.

Another possible presentation method can be applied in electronic devices such as mobile phones and tablet computers. In the case of displaying AR data including special effect data of virtual objects, after the AR device generates a real scene image based on the real scene, the AR data displayed on the AR device may be the real scene image superimposed with the image of the virtual body.

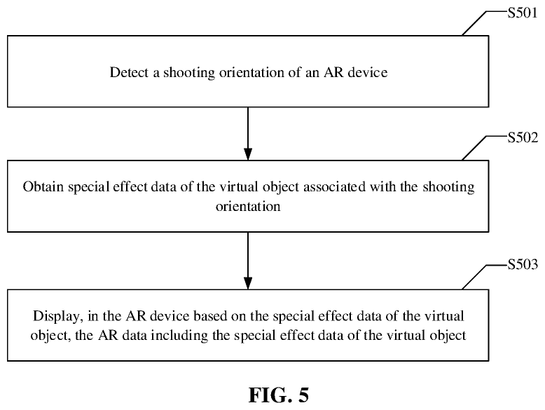

The present disclosure also provides another method for presenting an AR scene. As shown in FIG. 5, a schematic flow diagram of another method for presenting AR scene provided by the present disclosure includes the following operations.

In S501, a shooting orientation of an AR device is detected.

The AR device may have a built-in angular velocity sensor. In this case, the shooting orientation may be obtained based on the angular velocity sensor in the AR device. The angular velocity sensor may include, for example, a gyroscope and an inertial measurement unit (IMU), etc.

Alternatively, when the AR device is equipped with an image collection component, such as a camera, the shooting orientation can be determined by a real scene image collected by the camera.

In S502, special effect data of the virtual object associated with the shooting orientation is obtained.

In some embodiments, the special effect data of each virtual object may be preset with a shooting range. In the case of obtaining the special effect data of virtual objects associated with the shooting orientation, based on the shooting range preset for special effect data of each virtual object, the corresponding special effect data of the target virtual object whose preset shooting range includes the shooting orientation of the AR device is determined, and the special effect data of the target virtual object is determined as the special effect data of the virtual object associated with the shooting orientation of the AR device. Exemplarily, different virtual portraits can be deployed at different height positions on the same wall, and each virtual portrait can have a preset shooting range. For example, the preset shooting range of virtual portrait A is 30°˜60°. If the shooting orientation of the AR device is 40°, the virtual portrait A can be determined as the special effect data of the virtual object associated with this shooting orientation.

In S503, the AR data including the special effect data of the virtual object is displayed in the AR device based on the special effect data of the virtual object.

In this operation, the method for displaying, in the AR device based on the special effect data of the virtual object, the AR data including the special effect data of the virtual object is the same as that described in the above operation S103, which will not be repeated here.

Those skilled in the art can understand that in the methods of the embodiments of the present disclosure, the operations do not need to be performed strictly in an order recited in the description but can be performed in an order determined based on their functions and possible inner logics. Thus, the order of operations recited above does not constitute any limitations.

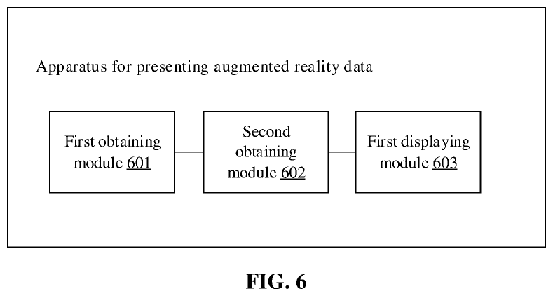

Based on the same concept, an embodiment of the present disclosure also provides an apparatus for presenting AR data. Referring to FIG. 6, FIG. 6 is a schematic structural diagram of an apparatus for presenting AR data provided by an embodiment of the present disclosure. The apparatus includes a first obtaining module 601, a second obtaining module 602 and a first displaying module 603.

The first obtaining module 601 is configured to obtain position information of an AR device, and transmit the position information of the AR device to a second obtaining module 602.

The second obtaining module 602 is configured to: when it is detected that a position corresponding to the position information is located within a position range of a target reality area, obtain special effect data of a virtual object associated with the target reality area, and transmit the special effect data of the virtual object to a first displaying module.

The first displaying module 603 is configured to: display, in the AR device based on the special effect data of the virtual object, the AR data including the special effect data of the virtual object.

In a possible implementation, when obtaining the special effect data of the virtual object associated with the target reality area, the second obtaining module 602 is configured to perform at least one of:

obtaining the special effect data of a virtual object whose corresponding geographic position in a real scene is located within the position range of the target reality area; or

obtaining the special effect data of a virtual object whose corresponding geographic position in a real scene is located outside the position range of the target reality area.

In a possible implementation, when obtaining the special effect data of the virtual object whose corresponding geographic position in the real scene is located outside the position range of the target reality area, the second obtaining module 602 is configured to:

obtain the special effect data of a virtual object whose corresponding geographic position in the real scene is located outside the position range of the target reality area and which meets a preset condition;

herein, the preset condition includes at least one of:

a distance from the corresponding geographic position of the virtual object in the real scene to the target reality area is within a set distance range; and

a shooting orientation of the AR device is within a set orientation range.

In a possible implementation, when detecting that the position corresponding to the position information is located within the position range of the target reality area, the second obtaining module 602 is configured to:

responsive to that geographic coordinates of the position information fall within a geographic coordinate range of the target reality area, detect that the position corresponding to the position information is located within the position range of the target reality area.

In a possible implementation, when detecting that the position corresponding to the position information is located within the position range of the target reality area, the second obtaining module 602 is configured to:

based on the position information of the AR device and information of the corresponding geographic position of the virtual object in the real scene, determine a distance between the AR device and the corresponding geographic position of the virtual object in the real scene; and

responsive to that a determined distance is less than a set distance threshold, determine that the position corresponding to the position information is located within the position range of the target reality area.

In a possible implementation, when obtaining the special effect data of the virtual object associated with the target reality area, the second obtaining module 602 is configured to:

detect a shooting orientation of the AR device; and

obtain the special effect data of a virtual object associated with both the target reality area and the shooting orientation.

In a possible implementation, when obtaining special effect data of the virtual object associated with the target reality area, the second obtaining module 602 is configured to:

obtain pose data of the AR device in a real scene; and

based on the pose data of the AR device in the real scene and pose data of the virtual object in a three-dimensional scene model used for representing the real scene, determine the special effect data of the virtual object associated with the target reality area.

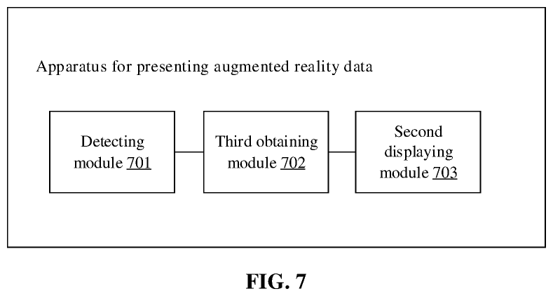

Based on the same concept, the embodiment of the present disclosure also provides another apparatus for presenting AR data. Referring to FIG. 7, FIG. 7 is a schematic structural diagram of an apparatus for presenting AR data provided by an embodiment of the present disclosure. The apparatus includes a detecting module 701, a third obtaining module 702 and a second displaying module 703.

The detecting module 701 is configured to detect a shooting orientation of an AR device, and transmit the shooting orientation of the AR device to a third obtaining module 702.

The third obtaining module 702 is configured to obtain special effect data of a virtual object associated with the shooting orientation, and transmit the special effect data of the virtual object to a second displaying module 703.

The second displaying module 703 is configured to: display, in the AR device based on the special effect data of the virtual object, the AR data including the special effect data of the virtual object.

In some embodiments, the functions or contained templates of the apparatus provided in the embodiments of the present disclosure can be configured to implement the methods described in the method embodiments. The methods can be performed with the reference to the description of the method embodiments. For the sake of brevity, this will not be repeated here.

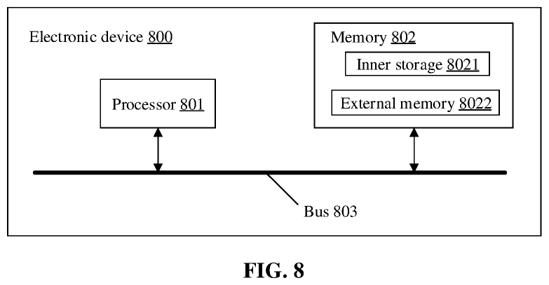

Based on the same technical concept, the embodiments of the present disclosure also provide an electronic device. Referring to FIG. 8, FIG. 8 is a schematic structural diagram of an electronic device provided by an embodiment of the present disclosure. The electronic device includes a processor 801, a memory 802 and a bus 803. The memory 802, which includes an inner storage 8021 and an external memory 8022, is configured to store executable instructions. The inner storage 8021 here is also called an internal memory, and is configured to temporarily store operational data in the processor 801 and data exchanged with an external memory 8022 such as a hard disk. The processor 801 exchanges data with the external memory 8022 through the inner storage 8021. When the electronic device 800 is running, the processor 801 and the memory 802 communicate through the bus 803, causing the processor 801 to implement the following instructions:

obtaining position information of an AR device;

when it is detected that the position corresponding to the position information is located within a position range of a target reality area, obtaining special effect data of a virtual object associated with the target reality area; and

displaying, in the AR device based on the special effect data of the virtual object, the AR data including the special effect data of the virtual object.

For the process of the processing executed by the processor 801, reference may be made to the description in the foregoing method embodiment which will not be repeated here.

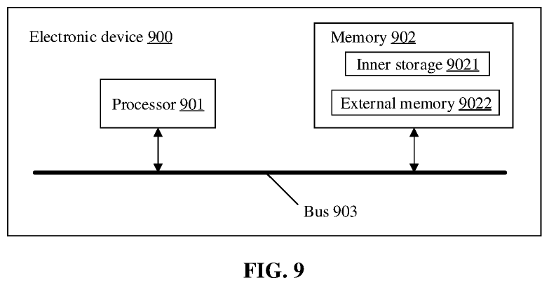

Based on the same technical concept, the embodiments of the present disclosure also provide an electronic device. Referring to FIG. 9, FIG. 9 is a schematic structural diagram of an electronic device provided by an embodiment of the present disclosure. The electronic device includes a processor 901, a memory 902 and a bus 903. The memory 902, which includes an inner storage 9021 and an external memory 9022, is configured to store executable instructions. The inner storage 9021 here is also called an internal memory, and is configured to temporarily store operational data in the processor 901 and data exchanged with an external memory 9022 such as a hard disk. The processor 901 exchanges data with the external memory 9022 through the inner storage 9021. When the electronic device 900 is running, the processor 901 and the memory 902 communicate through the bus 903, causing the processor 901 to implement the following instructions:

detecting a shooting orientation of the AR device;

obtaining special effect data of a virtual object associated with the shooting orientation; and

displaying, in the AR device based on the special effect data of the virtual object, the AR data including the special effect data of the virtual object.

For the process of the processing implemented by the processor 901, reference may be made to the description in the method embodiment which will not be repeated here.

In addition, the embodiments of the present disclosure also provide a computer-readable storage medium having stored thereon computer programs configured to implement, when being run by a processor, a method for presenting AR data described in the method embodiment.

A computer program product of the method for presenting AR data provided by an embodiment of the present disclosure includes a computer-readable storage medium having stored thereon program codes. The program codes include instructions that can be used for implementing operations of the method for presenting AR data described in the method embodiment. The implementation may be performed with reference to the method embodiment which will not be repeated here.

Those skilled in the art can clearly understand that, for the convenience and conciseness of the description, the working process of the system and the apparatus described above can refer to the corresponding process in the method embodiment which will not be repeated here. In the several embodiments provided by the disclosure, it should be understood that the disclosed system, apparatus and method may be implemented in other ways. For example, the apparatus embodiments described above are only illustrative. For example, the division of the units is only a logical function division, and there may be other divisions in actual implementation. For example, multiple units or components may be combined or integrated into another system, or some features may be ignored or not implemented. In addition, the displayed or discussed mutual coupling or direct coupling or communication connection may be indirect coupling or communication connection through some interfaces, apparatuses or units, and may be in electrical, mechanical or other forms.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the present embodiments.

In addition, the functional units in each embodiment of the disclosure may be integrated into one processing unit, or each unit may exist separately and physically, or two or more units may be integrated into one unit.

If the function is implemented in the form of a software functional unit and is sold or used as an independent product, it can be stored in a computer readable storage medium. Based on such an understanding, the technical solution of the disclosure or the part that contributes to the related art or the part of the technical solution may be embodied in the form of a software product essentially, and the computer software product is stored in a storage medium includes several instructions to make a computer device (which may be a personal computer, a server or a network device, etc.) execute all or part of the operations of the methods described in the each embodiment of the disclosure. The aforementioned storage medium includes: U disks, mobile hard disks, read-only memories (ROM), random access memories (RAM), magnetic disks or optical disks and other media that can store program codes.

The foregoing description is only the specific implementation of the disclosure. However, the protection scope of the disclosure is not limited thereto. Any variations or replacements apparent to those skilled in the art within the technical scope disclosed by the present disclosure shall fall within the protection scope of the present disclosure. Therefore, the protection scope of the disclosure shall be subject to the protection scope of the claims.

### INDUSTRIAL APPLICABILITY

The present disclosure relates to a method and an apparatus for presenting AR data, an electronic device and a storage medium. The method includes: obtaining position information of an AR device; when it is detected that a position corresponding to the position information is located within a position range of a target reality area, obtaining special effect data of a virtual object associated with the target reality area; and displaying, in the AR device based on the special effect data of the virtual object, the AR data including the special effect data of the virtual object. In this way, AR data including special effect data of different virtual objects can be displayed in AR devices with different position information, which improves the display effect of the AR scene.

1. A method for presenting augmented reality (AR) data, comprising:
obtaining position information of an AR device;
when it is detected that a position corresponding to the position information is located within a position range of a target reality area, obtaining special effect data of a virtual object associated with the target reality area; and
displaying, in the AR device based on the special effect data of the virtual object, the AR data comprising the special effect data of the virtual object.

2. The method of claim 1, wherein obtaining the special effect data of the virtual object associated with the target reality area comprises at least one of:
obtaining the special effect data of a virtual object whose corresponding geographic position in a real scene is located within the position range of the target reality area; or
obtaining the special effect data of a virtual object whose corresponding geographic position in a real scene is located outside the position range of the target reality area.

3. The method of claim 2, wherein obtaining the special effect data of the virtual object whose corresponding geographic position in the real scene is located outside the position range of the target reality area comprises:
obtaining the special effect data of a virtual object whose corresponding geographic position in the real scene is located outside the position range of the target reality area and which meets a preset condition,
wherein the preset condition comprises at least one of:
a distance from the corresponding geographic position of the virtual object in the real scene to the target reality area is within a set distance range; or
a shooting orientation of the AR device is within a set orientation range.

4. The method of claim 2, wherein detecting that the position corresponding to the position information is located within the position range of the target reality area comprises:
responsive to that geographic coordinates of the position information fall within a geographic coordinate range of the target reality area, detecting that the position corresponding to the position information is located within the position range of the target reality area.

5. The method of claim 3, wherein detecting that the position corresponding to the position information is located within the position range of the target reality area comprises:
responsive to that geographic coordinates of the position information fall within a geographic coordinate range of the target reality area, detecting that the position corresponding to the position information is located within the position range of the target reality area.

6. The method of claim 2, wherein detecting that the position corresponding to the position information is located within the position range of the target reality area comprises:
based on the position information of the AR device and information of the corresponding geographic position of the virtual object in the real scene, determining a distance between the AR device and the corresponding geographic position of the virtual object in the real scene; and
responsive to that a determined distance is less than a set distance threshold, determining that the position corresponding to the position information is located within the position range of the target reality area.

7. The method of claim 1, wherein obtaining the special effect data of the virtual object associated with the target reality area comprises:
detecting a shooting orientation of the AR device; and
obtaining the special effect data of a virtual object associated with both the target reality area and the shooting orientation.

8. The method of claim 1, wherein obtaining special effect data of the virtual object associated with the target reality area comprises:
obtaining pose data of the AR device in a real scene; and
based on the pose data of the AR device in the real scene and pose data of the virtual object in a three-dimensional scene model used for representing the real scene, determining the special effect data of the virtual object associated with the target reality area.

9. The method of claim 7, wherein obtaining special effect data of the virtual object associated with the target reality area comprises:
obtaining pose data of the AR device in a real scene; and
based on the pose data of the AR device in the real scene and pose data of the virtual object in a three-dimensional scene model used for representing the real scene, determining the special effect data of the virtual object associated with the target reality area.

10. An apparatus for presenting augmented reality (AR) data, comprising:
a memory storing processor-executable instructions; and
a processor configured to execute the stored processor-executable instructions to perform operations of:
obtaining position information of an AR device;
when it is detected that a position corresponding to the position information is located within a position range of a target reality area, obtaining special effect data of a virtual object associated with the target reality area; and
displaying, in the AR device based on the special effect data of the virtual object, the AR data comprising the special effect data of the virtual object.

11. The apparatus of claim 10, wherein obtaining the special effect data of the virtual object associated with the target reality area comprises at least one of:
obtaining the special effect data of a virtual object whose corresponding geographic position in a real scene is located within the position range of the target reality area; or
obtaining the special effect data of a virtual object whose corresponding geographic position in a real scene is located outside the position range of the target reality area.

12. The apparatus of claim 11, wherein obtaining the special effect data of the virtual object whose corresponding geographic position in the real scene is located outside the position range of the target reality area comprises:
obtaining the special effect data of a virtual object whose corresponding geographic position in the real scene is located outside the position range of the target reality area and which meets a preset condition,
wherein the preset condition comprises at least one of:
a distance from the corresponding geographic position of the virtual object in the real scene to the target reality area is within a set distance range; or
a shooting orientation of the AR device is within a set orientation range.

13. The apparatus of claim 11, wherein detecting that the position corresponding to the position information is located within the position range of the target reality area comprises:
responsive to that geographic coordinates of the position information fall within a geographic coordinate range of the target reality area, detecting that the position corresponding to the position information is located within the position range of the target reality area.

14. The apparatus of claim 12, wherein detecting that the position corresponding to the position information is located within the position range of the target reality area comprises:
responsive to that geographic coordinates of the position information fall within a geographic coordinate range of the target reality area, detecting that the position corresponding to the position information is located within the position range of the target reality area.

15. The apparatus of claim 11, wherein detecting that the position corresponding to the position information is located within the position range of the target reality area comprises:
based on the position information of the AR device and information of the corresponding geographic position of the virtual object in the real scene, determining a distance between the AR device and the corresponding geographic position of the virtual object in the real scene; and
responsive to that a determined distance is less than a set distance threshold, determining that the position corresponding to the position information is located within the position range of the target reality area.

16. The apparatus of claim 10, wherein obtaining the special effect data of the virtual object associated with the target reality area comprises:
detecting a shooting orientation of the AR device; and
obtaining the special effect data of a virtual object associated with both the target reality area and the shooting orientation.

17. The apparatus of claim 10, wherein obtaining special effect data of the virtual object associated with the target reality area comprises:
obtaining pose data of the AR device in a real scene; and
based on the pose data of the AR device in the real scene and pose data of the virtual object in a three-dimensional scene model used for representing the real scene, determining the special effect data of the virtual object associated with the target reality area.

18. The apparatus of claim 16, wherein obtaining special effect data of the virtual object associated with the target reality area comprises:
obtaining pose data of the AR device in a real scene; and
based on the pose data of the AR device in the real scene and pose data of the virtual object in a three-dimensional scene model used for representing the real scene, determining the special effect data of the virtual object associated with the target reality area.

19. A non-transitory computer-readable storage medium having stored thereon computer-readable instructions that, when executed by a processor, cause the processor to performing operations of:
obtaining position information of an AR device;
when it is detected that a position corresponding to the position information is located within a position range of a target reality area, obtaining special effect data of a virtual object associated with the target reality area; and
displaying, in the AR device based on the special effect data of the virtual object, the AR data comprising the special effect data of the virtual object.

20. The non-transitory computer-readable storage medium of claim 19, wherein obtaining the special effect data of the virtual object associated with the target reality area comprises at least one of:
obtaining the special effect data of a virtual object whose corresponding geographic position in a real scene is located within the position range of the target reality area; or
obtaining the special effect data of a virtual object whose corresponding geographic position in a real scene is located outside the position range of the target reality area.
